(19) United States
(12) Patent Application Publication
(10) Pub. No.: US 2018/0313702 A1
(43) Pub. Date: Nov. 1, 2018

(54) CHEMICAL CONTAINERS HAVING A SOURCE AUTHENTICATION AND METHODS OF MAKING AND USING THE SAME

(71) Applicants: SYNGENTA PARTICIPATIONS AG, Basel (CH); SYNGENTA CROP PROTECTION LLC, Greensboro, NC (US)

(72) Inventor: Timothy Michael Cotter, Greensboro, NC (US)

(73) Assignee: SYNGENTA PARTICIPATIONS AG, Basel (CH)

(21) Appl. No.: 15/770,831

(22) PCT Filed: Oct. 25, 2016
(86) PCT No.: PCT/US16/58634

§ 371 Date: Apr. 25, 2018

Related U.S. Application Data
(60) Provisional application No. 62/246,873, filed on Oct. 27, 2015.

(51) Int. Cl. G01K 11/16; B65D 25/56; C08K 5/00

(52) U.S. Cl. CPC G01K 11/16; C09K 9/00; C08K 5/0041; B65D 25/56

(57) ABSTRACT

A container for holding a liquid, including a container body formed from a primary resin, the container body surrounding a container volume and an authentication strip positioned along a wall of the container body. The authentication strip comprising an authentication resin that contains a color changing pigment, which responds to changes in temperature of light.

### FIELD OF TECHNOLOGY

The current disclosure relates generally to containers for chemical storage and shipping and more specifically to containers (e.g., bottles) for agrochemicals configured to provide improved source authentication.

### BACKGROUND

Chemicals are commonly shipped and stored in plastic containers (e.g., bottles). Like many other markets (e.g., apparel, handbags, watches, etc.), the chemical market has been infiltrated with counterfeit goods.

Efforts continue to fight counterfeit goods in the chemical industry.

### SUMMARY

The present invention addresses applicant's need for providing containers for chemicals, wherein the containers provide a source authentication feature so that a user can verify the source of the chemicals. Accordingly, the present invention is directed to containers for holding and storing a liquid. In one exemplary embodiment, the container of the present invention comprises a container for holding a liquid, wherein the container comprises: (a) a container body formed from a primary resin; (b) a container volume surrounded by the container body; and (c) an authentication strip positioned along a wall of the container body, the authentication strip comprising an authentication resin that contains a color changing pigment. The color changing pigment may be, for example, a thermochromic pigment that changes color upon exposure to heat or a photochromic pigment that changes color upon exposure to light.

The present invention is further directed to methods of making containers that provide a source authentication feature. In one exemplary embodiment, the method of making a container of the present invention comprises: thermoforming a container body, the container body comprising a primary resin, a container volume surrounded by the container body, and an authentication strip positioned along a wall of the container body, the authentication strip comprising an authentication resin that contains a color changing pigment.

The present invention is even further directed to methods of using containers that provide a source authentication feature. In one exemplary embodiment, the method of using a container of the present invention comprises: exposing a container comprising a color changing pigment to a color-changing stimulus, the color-changing stimulus causing a color change of the color changing pigment from an original color to an activated color. In some embodiments, the color-changing stimulus comprises exposure of the color changing pigment to ultraviolet (UV) light. In other embodiments, the color-changing stimulus comprises exposure of the color changing pigment to heat (e.g., friction-generating heat).

These and other features and advantages of the present invention will become apparent after a review of the following detailed description of the disclosed embodiments and the appended claims.

### BRIEF DESCRIPTION OF THE FIGURES

The present invention is further described with reference to the appended figures, wherein:

FIG. 1 depicts a rear view of an exemplary container of the present invention;

FIG. 2 depicts a perspective view of the exemplary container shown in FIG. 1, and a threaded cap suitable for use with the exemplary container; and

FIG. 3 depicts a cross-sectional view of the exemplary container shown in FIG. 1 as viewed along line 3-3 shown in FIG. 1.

### DETAILED DESCRIPTION OF PREFERRED EMBODIMENTS

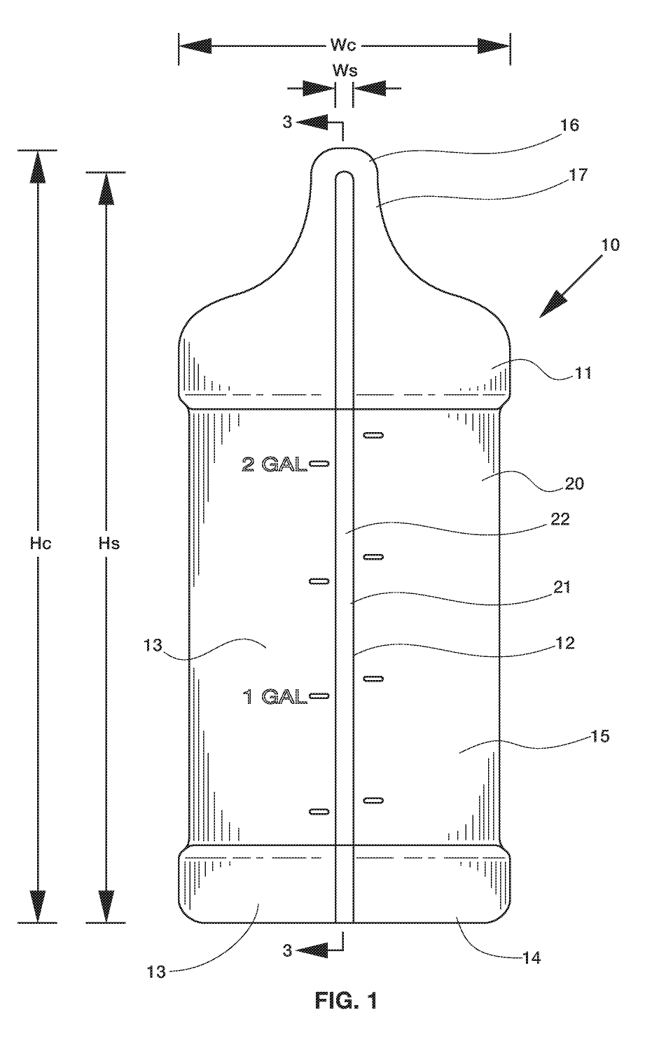

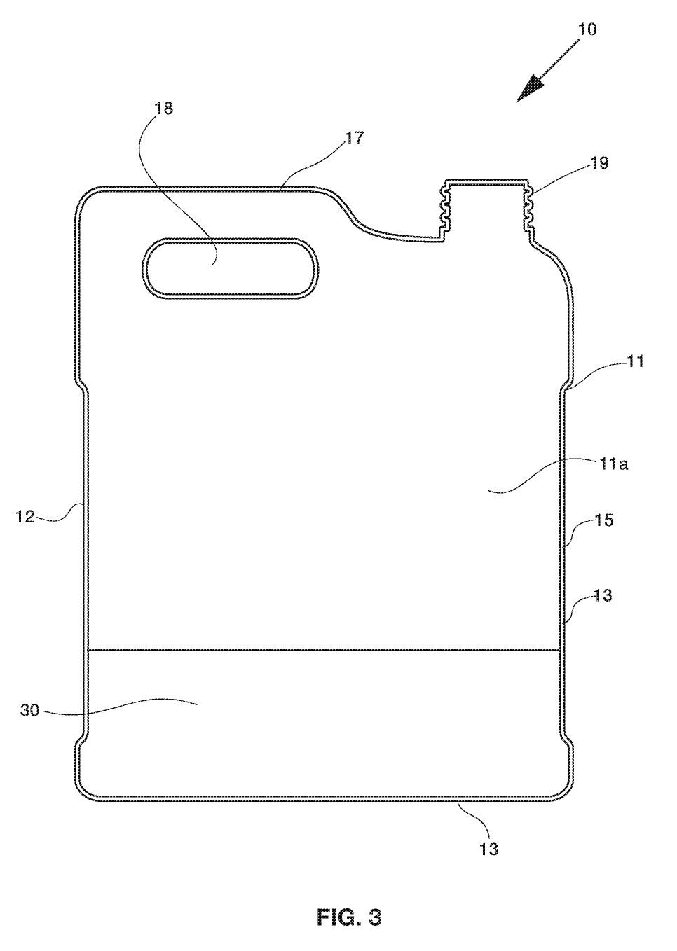

The present invention is directed to containers for holding and storing a liquid such as an agrochemical liquid. An exemplary container 10 of the present invention is shown in FIG. 1. As shown in FIG. 1, exemplary container 10 comprises: (a) a container body 11 formed from a primary resin 20; (b) a container volume 11a (e.g., about 10 liters (L) (or about 2.64 gallons (GAL)) as shown in FIGS. 1-3; see, for example, container volume 11a in FIG. 3) surrounded by the container body 11; and (c) an authentication strip 12 positioned along a wall 13 of the container body 11, the authentication strip 12 comprising an authentication resin 21 that contains a color changing pigment 22.

Primary resin 20, which forms a majority of container body 11, may comprise any desired container body-forming material. Suitable primary resin 20 materials for forming container body 11 include, but are not limited to, polyethylene, polypropylene, polyester, and polycarbonate. In some desired embodiments, primary resin 20 used to form container body 11 comprises a high density polyethylene (e.g., a polyethylene having a density of greater than about 0.96 g/cm³). High density polyethylenes suitable for use in the present invention are commercially available from a number of sources.

Authentication resin 21, which forms a majority of authentication strip 12, may comprise any desired authentication strip-forming material. Suitable authentication resin 21 materials for forming authentication strip 12 include, but are not limited to, polyethylene, polypropylene, polyester, and polycarbonate. In some desired embodiments, authentication resin 21 used to form authentication strip 12 comprises a high density polyethylene similar to, or identical to, the high density polyethylene used to form container body 11.

Color changing pigment 22 may comprise any commercially available thermochromic or photochromic pigment or both. In some embodiments, the color changing pigment 22 comprises a photochromic pigment that changes color upon exposure to ultraviolet (UV) light. When present, the photochromic pigment typically changes color upon exposure to ultraviolet (UV) light at a specific wavelength within a wavelength range of 400 nm to 100 nm.

In other embodiments, the color changing pigment 22 comprises a thermochromic pigment that changes color upon exposure to a temperature, for example, above about 33° C. Typically, when present, the thermochromic pigment changes color upon exposure to a temperature in the range of 33° C. to 45° C.

Regardless of whether color changing pigment 22 comprises a thermochromic or photochromic pigment, desirably, the color changing pigment 22 comprises a pigment that reversibly changes back to an original color once a color-changing stimulus (e.g., light) is removed from the color changing pigment 22. Further, regardless of whether color changing pigment 22 comprises a thermochromic pigment, photochromic pigment or both, desirably, the color changing pigment 22 is present in an amount sufficient to create a visually detectable change in color upon exposure to a color-changing stimulus.

Suitable thermochromic pigments for forming authentication strip 12 may include, but are not limited to, thermochromic pigments commercially available from OliKrom Smart Pigments (Pessec, France), or Thermographic Measurements Ltd. (Flintshire, UK), or SolarActive International Inc. (California, USA), or New Color Chemical Co., Ltd. (Xiamen, China). Suitable photochromic pigments for forming authentication strip 12 may include, but are not limited to, photochromic pigments commercially available from OliKrom Smart Pigments (Pessec, France), or Thermographic Measurements Ltd. (Flintshire, UK), or SolarActive International Inc. (California, USA), or New Color Chemical Co., Ltd (Xiamen, China).

Typically, container body 11 of container 10 comprises: from about 90.0 weight percent (wt %) to about 99.5 wt % of the primary resin 20; from about 10.0 wt % to about 0.5 wt % of the authentication resin 21; and from greater than 0.0 wt % to about 1.0 wt % of the color changing pigment 22, with all weight percents being based on a total weight of the container body 11. In some embodiments, container body 11 of container 10 may further comprise an additional pigment within primary resin 20, the additional pigment being a pigment that does not change color, and is present in an amount ranging from greater than 0.0 wt % to about 5.0 wt %, based on a total weight of the container body 11.

As shown in FIG. 1, exemplary authentication strip 12, formed from one or more of the above authentication resins 21 and one or more of the above color changing pigments 22, is positioned along (and in this case, within) wall 13 of container body 11. Exemplary authentication strip 12 has a strip height Hₛ and a strip width Wₛ. Typically, as shown in FIG. 1, strip height Hₛ is greater than strip width Wₛ. In some embodiments, Hₛ is at least 20 Wₛ.

In addition, as shown in FIG. 1, container body 11 has a container height H_{c}, and a container width W_{c}. Typically, as shown in FIG. 1, strip height Hₛ is at least 0.5 times container height H_{c}. In many examples, strip height Hₛ is in the range of at least one of 0.7 H_{c} to 1 H_{c}, and 0.8 H_{c} to 0.9 H_{c}.

In desired embodiments, exemplary authentication strip 12 has a transparency or translucence that enables a user to visually determine a level of liquid 30 within container body 11. See, for example, liquid 30 occupying a portion of container volume 11a within container body 11. Typically, authentication strip 12 has a transparency or translucence that is greater than a transparency or translucence of container body 11 formed by primary resin 20. More typically, authentication strip 12 has a transparency or translucence that enables a user to visually determine an amount of liquid 30 within container body 11, while container body 11 has a transparency or translucence that does not enable a user to visually determine an amount of liquid 30 within container body 11. In many examples, the authentication strip will be bound on each side by the primary resin, wherein the primary resin is pigmented and allows less transmission of light than the authentication strip. The transmission of light through authentication strip 12 and/or container body 11 can readily be measured by a spectrophotometer, such as the LCRT 2005-S Portable Light Transmittance Meter available from Gigahertz-Optik, Inc. (Newburyport, Mass.).

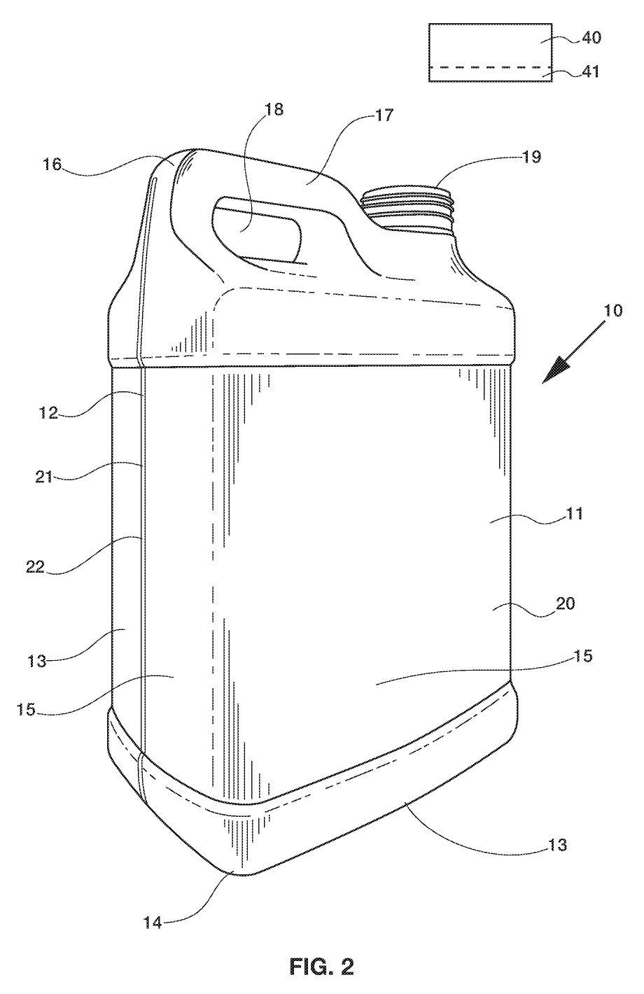

As shown in FIG. 2, exemplary container 10 may comprise: a base 14; one or more side walls 15 extending upward from the base 14; a container top 16; a container handle 17 comprising an aperture 18 extending through the container body 11; and a container outlet 19 (e.g., threaded container outlet 19) configured to engage with a threaded container cap 40. Desirably, the threaded cap 40 includes a tamper evident (TE) strip 41 that provides an indication that exemplary container 10 has been opened.

It should be understood that although exemplary container 10 shown in FIGS. 1-3 has a configuration as shown (e.g., a rectangular-shaped cross-sectional area in both the height and width directions), containers of the present invention may have any desired configuration. For example, containers of the present invention may have any overall shape with any cross-sectional area shape in each of the height and width directions, such cross-sectional area shapes including, but not limited to, a triangular shape, a square shape, a rectangular shape, a hexagonal shape, a star shape, or any combination thereof.

It should be further understood that although exemplary container 10 shown in FIGS. 1-3 has a container volume of about 10.0 L (2.64 GAL), containers of the present invention may have any desired container volume. Typically, containers of the present invention have a container volume ranging from about 1.0 L (0.26 GAL) to about 20 L (5.28 GAL), more typically, from about 3.8 liters (L) (1.0 GAL) to about 10 L (2.64 GAL).

The present invention is further directed to methods of making containers that provide a source authentication feature. In one exemplary embodiment, the method of making a container, such as exemplary container 10, comprises: thermoforming a container body 11 comprising at least one primary resin 20, wherein container body 11 has a container volume 11a surrounded by container body 11, and an authentication strip 12 positioned along a wall 13 of container body 11, authentication strip 12 comprising an authentication resin 21 and a color changing pigment 22. Typically, the thermoforming step comprises a molding step such as an injection molding or a blow molding step. Desirably, the method of making a container, such as exemplary container 10, comprises incorporating authentication strip 12 within a wall 13 (e.g., side wall 15) of container body 11.

In some embodiments, the method of making a container of the present invention comprises blow molding the container body 11 and the authentication strip 12 so that the authentication strip 12 is positioned within and along a side wall 15 of the container body 11. In some embodiments, the authentication strip 12 positioning step comprises placing the authentication strip 12 within a mold (not shown) prior to a thermoforming step. In other embodiments, the authentication strip 12 positioning step comprises simultaneously introducing the primary resin 20, and the authentication resin 21 containing the color changing pigment 22 into a mold.

Other method steps that may be used in the methods of making a container of the present invention may include, but are not limited to, one or more of the following steps: introducing the primary resin 20 into the mold; introducing the authentication resin 21 containing the color changing pigment 22 into the mold; and performing the thermoforming and positioning steps simultaneously.

The present invention is even further directed to methods of using the herein-described containers that provide a source authentication feature. In one exemplary embodiment, the method of using a container of the present invention comprises: exposing container 10 comprising color changing pigment 22 to a color-changing stimulus, the color-changing stimulus causing a color change of color changing pigment 22 from an original color to an activated color. In some embodiments, the color-changing stimulus comprises exposure of color changing pigment 22 to ultraviolet (UV) light. In other embodiments, the color-changing stimulus comprises exposure of color changing pigment 22 to heat (e.g., friction-generating heat from a friction-producing object such as a human hand or human finger).

Methods of using the containers of the present invention may further include, but are not limited to, one or more of the following steps: transporting the container 10 from a first location to a second location; inputting a liquid agrochemical 30 (see, FIG. 3) into the container 10; and storing a liquid agrochemical 30 within the container 10.

Containers of the present invention are particularly useful for storing an agrochemical 30, typically a liquid agrochemical 30, within the container volume 11a. The agrochemical 30 may comprise at least one of: a herbicide, a fungicide, an insecticide, a plant growth regulator, and a plant nutrient. A variety of agrochemicals are described in the Pesticide Manual, 12th Edition, for example.

The term “fungicide” as used herein means a compound that controls, modifies, or prevents the growth of fungi. The term “fungicidally effective amount” means the quantity of such a compound or combination of such compounds that is capable of producing an effect on the growth of fungi. Controlling or modifying effects include all deviation from natural development, such as killing, retardation and the like, and prevention includes barrier or other defensive formation in or on a plant to prevent fungal infection.

The term “herbicide” as used herein means a compound that controls or modifies the growth of plants. The term “herbicidally effective amount” means the quantity of such a compound or combination of such compounds that is capable of producing a controlling or modifying effect on the growth of plants. Controlling or modifying effects include all deviation from natural development, for example killing, retardation, leaf burn, albinism, dwarfing and the like.

The term “insecticide” as used herein means a compound that controls or modifies the growth of insects. The term “insecticidally effective amount” means the quantity of such a compound or combination of such compounds that is capable of killing, controlling, or infecting insects, retarding the growth or reproduction of insects, reducing an insect population, and/or reducing damage to plants caused by insects.

Examples of herbicides include acetochlor; acifluorfen-sodium; aclonifen; alachlor; alloxydim; ametryn; amicarbazone; amidosulfuron; aminocyclopyrachlor; aminopyralid; amitrole; asulam; atrazine; bensulfuron-methyl; bentazone; bicyclopyrone; bifenox; bispyribac-sodium; bromacil; bromoxynil; butafenacil; cafenstrole; carfentrazone-ethyl; chlorimuron-ethyl; chlorotoluron; cinosulfuron; clethodim; clodinafop-propargyl; clomazone; clopyralid; cyhalofop-butyl; 2,4-D (including the choline salt and 2-ethylhexyl ester thereof); daimuron; desmedipham; dicamba (including the aluminum, aminopropyl, bis-aminopropylmethyl, choline, diglycolamine, dimethylamine, dimethylammonium, potassium and sodium salts thereof); diclofop-methyl; difenzoquat; diflufenican; diflufenzopyr; dimethachlor; I dimethenamid-P; diquat dibromide; diuron; esprocarb; ethofumesate; fenoxaprop-P-ethyl; fenquinotrione; flazasulfuron; florasulam; fluazifop-P-butyl; flucarbazone-sodium; flufenacet; flumetralin; flumetsulam; flumioxazin; flupyrsulfuron-methyl-sodium; fluroxypyr-meptyl; fluthiacet-methyl; fomesafen; foramsulfuron; glufosinate (including the ammonium salt thereof); glyphosate (including the diammonium, isopropylammonium and potassium salts thereof); halauxifen-methyl; halosulfuron-methyl; haloxyfop-methyl; hexazinone; imazamox; imazapic; imazapyr; imazaquin; imazethapyr; indaziflam; iodosulfuron-methyl-sodium; iofensulfuron; iofensulfuron-sodium; ioxynil; ipfencarbazone; isoxaben; isoxaflutole; lactofen; linuron; mecoprop-P; mefenacet; mesosulfuron; mesosulfuron-methyl; mesotrione; metamitron; metobromuron; metolachlor; metoxuron; metribuzin; metsulfuron; molinate; napropamide; nicosulfuron; norflurazon; orthosulfamuron; oxadiargyl; oxadiazon; oxyfluorfen; paraquat dichloride; pendimethalin; penoxsulam; phenmedipham; picloram; picolinafen; pinoxaden; pretilachlor; primisulfuron-methyl; prodiamine; prometryn; propachlor; propanil; propaquizafop; propham; propyzamide; prosulfocarb; prosulfuron; pyrasulfotole; pyrazolynate; pyrazosulfuron-ethyl; pyribenzoxim; pyridate; pyriftalid; pyrithiobac-sodium; pyroxasulfone; pyroxsulam; quinclorac; quizalofop-P-ethyl; rimsulfuron; saflufenacil; sethoxydim; S-metolachlor; sulcotrione; sulfentrazone; tebuthiuron; tefuryltrione; tembotrione; terbuthylazine; terbutryn; thiencarbazone; thifensulfuron; tiafenacil; tolpyralate; topramezone; tralkoxydim; triafamone; triasulfuron; tribenuron-methyl; triclopyr; trifloxysulfuron-sodium; trifludimoxazin and tritosulfuron.

Examples of fungicides include compounds selected from those in the following chemical or functional classes: 1,2,4-thiadiazoles, 2,6-dinitroanilines, acylalanines, aliphatic nitrogenous compounds, amidines, aminopyrimidinols, anilides, anilino-pyrimidines, anthraquinones, antibiotics, aryl-phenylketones, benzamides, benzene-sulfonamides, benzimidazoles, benzothiazoles, benzothiodiazoles, benzothiophenes, benzoylpyridines, benzthiadiazoles, benzylcarbamates, butylamines, carbamates, carboxamides, carpropamids, chloronitriles, cinnamic acid amides, copper containing compounds, cyanoacetamideoximes, cyanoacrylates, cyanoimidazoles, cyanomethylene-thiazolidines, dicarbonitriles, dicarboxamides, dicarboximides, dimethylsulphamates, dinitrophenol carbonates, dinitrophenysl, dinitrophenyl crotonates, diphenyl phosphates, dithiino compounds, dithiocarbamates, dithioethers, dithiolanes, ethyl-amino-thiazole carboxamides, ethyl-phosphonates, furan carboxamides, glucopyranosyls, glucopyranoxyls, glutaronitriles, guanidines, herbicides/plant growth regulatosr, hexopyranosyl antibiotics, hydroxy(2-amino)pyrimidines, hydroxyanilides, hydroxyisoxazoles, imidazoles, imidazolinones, insecticides/plant growth regulators, isobenzofuranones, isoxazolidinyl-pyridines, isoxazolines, maleimides, mandelic acid amides, mectin derivatives, morpholines, norpholines, n-phenyl carbamates, organotin compounds, oxathiin carboxamides, oxazoles, oxazolidine-diones, phenols, phenoxy quinolines, phenyl-acetamides, phenylamides, phenylbenzamides, phenyl-oxo-ethyl-thiophenes amides, phenylpyrroles, phenylureas, phosphorothiolates, phosphorus acids, phthalamic acids, phthalimides, picolinamides, piperazines, piperidines, plant extracts, polyoxins, propionamides, pthalimides, pyrazole-4-carboxamides, pyrazolinones, pyridazinones, pyridines, pyridine carboxamides, pyridinyl-ethyl benzamides, pyrimdinamines, pyrimidines, pyrimidine-amines, pyrimidione-hydrazone, pyrrolidines, pyrrolquinoliones, quinazolinones, quinolines, quinoline derivatives, quinoline-7-carboxylic acids, quinoxalines, spiroketalamines, strobilurins, sulfamoyl triazoles, sulphamides, tetrazolyloximes, thiadiazines, thiadiazole carboxamides, thiazole carboxanides, thiocyanates, thiophene carboxamides, toluamides, triazines, triazobenthiazoles, triazoles, triazole-thiones, triazolo-pyrimidylamine, valinamide carbamates, ammonium methyl phosphonates, arsenic-containing compounds, benyimidazolylcarbamates, carbonitriles, carboxanilides, carboximidamides, carboxylic phenylamides, diphenyl pyridines, furanilides, hydrazine carboxamides, imidazoline acetates, isophthalates, isoxazolones, mercury salts, organomercury compounds, organophosphates, oxazolidinediones, pentylsulfonyl benzenes, phenyl benzamides, phosphonothionates, phosphorothioates, pyridyl carboxamides, pyridyl furfuryl ethers, pyridyl methyl ethers, SDHIs, thiadiazinanethiones, thiazolidines.

Specific fungicides examples include etridiazole, fluazinam, benalaxyl, benalaxyl-M (kiralaxyl), furalaxyl, metalaxyl, metalaxyl-M (mefenoxam), dodicin, N′-(2,5-Dimethyl-4-phenoxy-phenyl)-N-ethyl-N-methyl-formamidine, N′-[4-(4,5-Dichloro-thiazol-2-yloxy)-2,5-dimethyl-phenyl]-N-ethyl-N-methyl-formamidine, N′-[4-[[3-[(4-chlorophenyl)methyl]-1,2,4-thiadiazol-5-yl]oxy]-2,5-dimethyl-phenyl]-N-ethyl-N-methyl-formamidine, ethirimol, 3′-chloro-2-methoxy-N-[(3RS)-tetrahydro-2-oxofuran-3-yl]acet-2′,6′-xylidide (clozylacon), cyprodinil, mepanipyrim, pyrimethanil, dithianon, aureofungin, blasticidin-S, biphenyl, chloroneb, dicloran, hexachlorobenzene, quintozene, tecnazene, (TCNB), tolclofos-methyl, metrafenone, 2,6-dichloro-N-(4-trifluoromethylbenzyl)-benzamide, fluopicolide (flupicolide), tioxymid, flusulfamide, benomyl, carbendazim, carbendazim chlorhydrate, chlorfenazole, fuberidazole, thiabendazole, thiophanate-methyl, benthiavalicarb, chlobenthiazone, probenazole, acibenzolar, bethoxazin, pyriofenone (IKF-309), acibenzolar-S-methyl, pyribencarb (KIF-7767), butylamine, 3-iodo-2-propinyl n-butylcarbamate (IPBC), iodocarb (isopropanyl butylcarbamate), isopropanyl butylcarbamate (iodocarb), Picarbutrazox, polycarbamate, propamocarb, tolprocarb, 3-(difluoromethyl)-N-(7-fluoro-1,1,3,3-tetramethyl-indan-4-yl)-1-methyl-pyrazole-4-carboxamide diclocymet, N-[(5-chloro-2-isopropyl-phenyl)methyl]-N-cyclopropyl-3-(difluoromethyl)-5-fluoro-1-methyl-pyrazole-4-carboxamide N-cyclopropyl-3-(difluoromethyl)-5-fluoro-N-[(2-isopropylphenyl)methyl]-1-methyl-pyrazole-4-carboxamide carpropamid, chlorothalonil, flumorph, oxine-copper, cymoxanil, phenamacril, cyazofamid, flutianil, thicyofen, chlozolinate, iprodione, procymidone, vinclozolin, bupirimate, dinocton, dinopenton, dinobuton, dinocap, meptyldinocap, diphenylamine, phosdiphen, 2,6-dimethyl-[1,4]dithiino[2,3-c:5,6-c′]dipyrrole-1,3,5,7(2H,6H)-tetraone, azithiram, etem, ferbam, mancozeb, maneb, metam, metiram (polyram), metiram-zinc, nabam, propineb, thiram, vapam (metam sodium), zineb, ziram, dithioether, isoprothiolane, ethaboxam, fosetyl, phosetyl-Al (fosetyl-al), methyl bromide, methyl iodide, methyl isothiocyanate, cyclafuramid, fenfuram, validamycin, streptomycin, (2RS)-2-bromo-2-(bromomethyl)glutaronitrile (bromothalonil), dodine, doguadine, guazatine, iminoctadine, iminoctadine triacetate, 2,4-D, 2,4-DB, kasugamycin, dimethirimol, fenhexamid, hymexazole, hydroxyisoxazole imazalil, imazalil sulphate, oxpoconazole, pefurazoate, prochloraz, triflumizole, fenamidone, Bordeaux mixture, calcium polysulfide, copper acetate, copper carbonate, copper hydroxide, copper naphthenate, copper oleate, copper oxychloride, copper oxyquinolate, copper silicate, copper sulphate, copper tallate, cuprous oxide, sulphur, carbaryl, phthalide (fthalide), dingjunezuo (Jun Si Qi), oxathiapiprolin, fluoroimide, mandipropamid, KSF-1002, benzamorf, dimethomorph, fenpropimorph, tridemorph, dodemorph, diethofencarb, fentin acetate, fentin hydroxide, carboxin, oxycarboxin, drazoxolon, famoxadone, m-phenylphenol, p-phenylphenol, tribromophenol (TBP), 2-[2-[(7,8-difluoro-2-methyl-3-quinolyl)oxy]-6-fluoro-phenyl]propan-2-ol 2-[2-fluoro-6-[(8-fluoro-2-methyl-3-quinolyeoxy]phenyl]propan-2-ol cyflufenamid, ofurace, oxadixyl, flutolanil, mepronil, isofetamid, fenpiclonil, fludioxonil, pencycuron, edifenphos, iprobenfos, pyrazophos, phosphorus acids, tecloftalam, captafol, captan, ditalimfos, CAS 517875-34-2 (DAS777), triforine, fenpropidin, piperalin, osthol, 1-methylcyclopropene, 4-CPA, chlormequat, clofencet, dichlorprop, dimethipin, endothal, ethephon, flumetralin, forchlorfenuron, gibberellic acid, gibberellins, hymexazol, maleic hydrazide, mepiquat, naphthalene acetamide, paclobutrazol, prohexadione, prohexadione-calcium, thidiazuron, tribufos (tributyl phosphorotrithioate), trinexapac, uniconazole, α-naphthalene acetic acid, polyoxin D (polyoxrim), BLAD, chitosan, fenoxanil, folpet, 3-(difluoromethyl)-N-methoxy-1-methyl-N-[1-methyl-2-(2,4,6-trichlorophenyl)ethyl]pyrazole-4-carboxamide, benzovindiflupyr (solatenol), bixafen, fluxapyroxad, furametpyr, isopyrazam, penflufen, penthiopyrad, sedaxane, fenpyrazamine, diclomezine, pyrifenox, boscalid, fluopyram, diflumetorim, fenarimol, 5-fluoro-2-(p-tolylmethoxy)pyrimidin-4-amine ferimzone, dimetachlone (dimethaclone), pyroquilon, proquinazid, ethoxyquin, quinoxyfen, 4,4,5-trifluoro-3,3-dimethyl-1-(3-quinolyl)isoquinoline 4,4-difluoro-3,3-dimethyl-1-(3-quinolyl)isoquinoline 5-fluoro-3,3,4,4-tetramethyl-1-(3-quinolyl)isoquinoline 9-fluoro-2,2-dimethyl-5-(3-quinolyl)-3H-1,4-benzoxazepine tebufloquin, oxolinic acid, chinomethionate (oxythioquinox, quinoxymethionate), spiroxamine, (E)-N-methyl-2- [2-(2, 5-dimethylphenoxymethyl) phenyl]-2-methoxy-iminoacetamide, (mandestrobin), azoxystrobin, coumoxystrobin, dimoxystrobin, enestroburin, enoxastrobin fenamistrobin, flufenoxystrobin, fluoxastrobin, kresoxim-methyl, mandestrobin, metaminostrobin, metominostrobin, orysastrobin, picoxystrobin, pyraclostrobin, pyrametostrobin, pyraoxystrobin, triclopyricarb, trifloxystrobin, amisulbrom, dichlofluanid, tolylfluanid, but-3-ynyl N-[6-[[(Z)-[(1-methyltetrazol-5-yl)-phenyl-methylene]amino]oxymethyl]-2-pyridyl]carbamate dazomet, isotianil, tiadinil, thifluzamide, benthiazole (TCMTB), silthiofam, zoxamide, anilazine, tricyclazole, (.+−.)-cis-1-(4-chlorophenyl)-2-(1H-1,2,4-triazol-1-yl)-cycloheptanol (huanjunzuo), 1-(5-bromo-2-pyridyl)-2-(2,4-difluorophenyl)-1,1-difluoro-3-(1,2,4-triazol-1-yl)propan-2-ol 2-(1-tert-butyl)-1-(2-chlorophenyl)-3-(1,2,4-triazol-1-yl)-propan-2-ol (TCDP), azaconazole, bitertanol (biloxazol), bromuconazole, climbazole, cyproconazole, difenoconazole, dimetconazole, diniconazole, diniconazole-M, epoxiconazole, etaconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimefon, triadimenol, triazoxide, triticonazole, 2-[[(1R,5S)-5-[(4-fluorophenyl)methyl] -1-hydroxy-2,2-dimethyl-cyclopentyl] methyl] -4H-1,2,4-triazole-3-thione 2-[[3-(2-chlorophenyl)-2-(2,4-difluorophenyl)oxiran-2-yl]methyl]-4H-1,2,4-triazole-3-thione ametoctradin (imidium), iprovalicarb, valifenalate, 2-benzyl-4-chlorophenol (Chlorophene), allyl alcohol, azafenidin, benzalkonium chloride, chloropicrin, cresol, daracide, dichlorophen (dichlorophene), difenzoquat, dipyrithione, N-(2-p-chlorobenzoylethyl)-hexaminium chloride, NNF-0721, octhilinone, oxasulfuron, propamidine, and propionic acid.

Examples of insecticides include compounds such as abamectin, acephate, acetamiprid, amidoflumet (S-1955), avermectin, azadirachtin, azinphos-methyl, bifenthrin, bifenazate, buprofezin, carbofuran, cartap, chlorantraniliprole (DPX-E2Y45), chlorfenapyr, chlorfluazuron, chlorpyrifos, chlorpyrifos-methyl, chromafenozide, clothianidin, cyflumetofen, cyfluthrin, beta-cyfluthrin, cyhalothrin, lambda-cyhalothrin, cypermethrin, cyromazine, deltamethrin, diafenthiuron, diazinon, dieldrin, diflubenzuron, dimefluthrin, dimethoate, dinotefuran, diofenolan, emamectin, endosulfan, esfenvalerate, ethiprole, fenothiocarb, fenoxycarb, fenpropathrin, fenvalerate, fipronil, flonicamid, flubendiamide, flucythrinate, tau-fluvalinate, flufenerim (UR-50701), flufenoxuron, fonophos, halofenozide, hexaflumuron, hydramethylnon, imidacloprid, indoxacarb, isofenphos, lufenuron, malathion, metaflumizone, metaldehyde, methamidophos, methidathion, methomyl, methoprene, methoxychlor, metofluthrin, monocrotophos, methoxyfenozide, nitenpyram, nithiazine, novaluron, noviflumuron (XDE-007), oxamyl, parathion, parathion-methyl, permethrin, phorate, phosalone, phosmet, phosphamidon, pirimicarb, profenofos, profluthrin, pymetrozine, pyrafluprole, pyrethrin, pyridalyl, pyrifluquinazon, pyriprole, pyriproxyfen, rotenone, ryanodine, spinetoram, spinosad, spirodiclofen, spiromesifen (BSN 2060), spirotetramat, sulprofos, tebufenozide, teflubenzuron, tefluthrin, terbufos, tetrachlorvinphos, thiacloprid, thiamethoxam, thiodicarb, thiosultap-sodium, tralomethrin, triazamate, trichlorfon and triflumuron.

Agrochemicals can also include bactericides such as streptomycin; acaricides such as amitraz, chinomethionat, chlorobenzilate, cyenopyrafen, cyhexatin, dicofol, dienochlor, etoxazole, fenazaquin, fenbutatin oxide, fenpropathrin, fenpyroximate, hexythiazox, propargite, pyridaben and tebufenpyrad; and biological agents such as Bacillus thuringiensis, Bacillus thuringiensis delta endotoxin, baculovirus, and entomopathogenic bacteria, virus and fungi.

The agrochemical may be present in any number of formulation types. For example, formulation types may include an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP), a soluble granule (SG) or any technically feasible formulation in combination with agriculturally acceptable adjuvants.

It should be understood that although the above-described containers and methods are described as “comprising” one or more components or steps, the above-described containers and methods may “comprise,” “consists of,” or “consist essentially of” any of the above-described components or steps of the containers and methods. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a container and/or method that “comprises” a list of elements (e.g., components or steps) is not necessarily limited to only those elements (or components or steps), but may include other elements (or components or steps) not expressly listed or inherent to the container and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define containers and/or methods that include materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described containers and/or methods may comprise, consist essentially of, or consist of any of the herein-described components and features, as shown in the figures with or without any feature(s) not shown in the figures. In other words, in some embodiments, the containers and/or methods of the present invention do not have any additional features other than those shown in the figures, and such additional features, not shown in the figures, are specifically excluded from the containers and/or methods. In other embodiments, the containers and/or methods of the present invention do have one or more additional features that are not shown in the figures.

In addition, it should be noted that the recitation of numerical ranges by endpoints in any of the embodiments disclosed herein includes all numbers subsumed within that range (e.g., the range about 1 to about 5 includes 1, 1.5, 2, 2.75, 3, 3.80, 4, and 5) and any range within that range (e.g., the range of about 1.5 to about 3.78 within the range of 1 to 5).

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims

### EXAMPLE 1

### Preparation of Containers With Improved Source Authentication

Exemplary containers similar to those shown in FIGS. 1-3 were prepared and used to store agrochemicals.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. A container for holding a liquid, the container comprising:
(a) a container body formed from a primary resin;
(b) a container volume surrounded by the container body comprising an agrochemical positioned within the container volume; and
(c) an authentication strip positioned along a wall of the container body, the authentication strip comprising an authentication resin that contains a color changing pigment.

2. The container of claim 1, wherein the color changing pigment is selected from at least one of a thermochromic pigment and a photochromic pigment.

3. The container of claim 1, wherein the color changing pigment comprises a photochromic pigment that changes color upon exposure to ultraviolet (UV) light.

4. The container of claim 1, wherein the color changing pigment comprises a photochromic pigment that changes color upon exposure to ultraviolet (UV) light at a specific wavelength within a wavelength range of 400 nm to 100 nm.

5. The container of claim 1, wherein the color changing pigment comprises a thermochromic pigment that changes color upon exposure to a temperature above about 33° C.

6. The container of claim 1, wherein the color changing pigment comprises a thermochromic pigment that changes color upon exposure to a temperature in the range of 33° C. to 45° C.

7. The container of claim 1, wherein the primary resin is a pigmented resin, wherein the pigmented resin does not comprise a color changing pigment.

8. The container of claim 1, wherein the authentication strip is integrally formed within the wall of the container body.

9. The container of claim 1, wherein the container body comprises a base, one or more side walls extending upward from the base, and a container top, and the authentication strip is positioned within the one or more side walls of the container body.

10. The container of claim 1, wherein the authentication strip has a strip height Hₛ, a strip width Wₛ, and Hₛ is selected from at least one of
greater than Wₛ; and
at least 20 Wₛ.

11. The container of claim 10, wherein the container body has a container height H_{c}, and a container width W_{c}, and Hₛ is at least 0.5 H_{c}.

12. The container of claim 1, wherein the container body comprises:
from about 90.0 weight percent (wt %) to about 99.0 wt % of the primary resin;
from about 10.0 wt % to about 1.0 wt % of the authentication resin; and
from greater than 0.0 wt % to about 1.0 wt % of the color changing pigment, with all weight percents being based on a total weight of the container body.

13. (canceled)

14. A method of making the container of claim 1, said method comprising:
thermoforming the container body; and
positioning the authentication strip along a wall of the container body.

15. The method of claim 14, wherein said positioning step comprises:
blow molding the container body and the authentication strip so that the authentication strip is positioned within and along a side wall of the container body, wherein the blow molding optionally comprises introducing the primary resin, and the authentication resin containing the color changing pigment into a mold.
